(19) United States
(12) Patent Application Publication
(10) Pub. No.: US 2023/0100182 A1
(43) Pub. Date: Mar. 30, 2023

(54) Alignment Of A Radar Measurement System With A Test Target

(71) Applicant: Resonant Sciences, LLC, Beavercreek, OH (US)

(72) Inventors: Ron Miller, Dayton, OH (US); Kevin Gross, Centerville, OH (US); Christopher Rice, Cedarville, OH (US); Jeremy Micah North, Dayton, OH (US)

(21) Appl. No.: 17/954,599

(22) Filed: Sep. 28, 2022

Related U.S. Application Data
(60) Provisional application No. 63/250,639, filed on Sep. 30, 2021.

(51) Int. Cl. G01S 7/40; G01S 13/89

(52) U.S. Cl. CPC G01S 7/40; G01S 13/89

(57) ABSTRACT

A radar measurement method includes aligning a radar antenna with a test target by comparing a pre-defined reference image of the test target with an image capture device image of the test target and moving a radar antenna that illuminates the test target to a radar antenna position relative to the test target based on the comparison.

### CROSS-REFERENCE TO RELATED APPLICATION

This claims the benefit of priority from Application No. 63/250,639, filed Sep. 30, 2021, which is incorporated by reference in its entirety.

### FIELD

This relates to the field of radar and, more particularly, to radar measurement of test targets.

There is often a need to perform repeated radar measurements of a test target as small changes are made to the test target, such as when thin coatings are applied, to determine how such changes affect the radar signature of the test target. Accurately repositioning the radar antenna with respect to the test target is useful to quantify the impact of the changes on the radar signature. Typically, repositioning errors of less than 1 cm and 0.25 degrees are required to ensure that any measured change in the radar signature is due to a change in the test target rather than a change in the relative position and orientation of the radar antenna between subsequent radar measurements.

### BRIEF SUMMARY

It would be advantageous to have precise knowledge of the radar antenna's pose, or position in space, with respect to the test target to be able to estimate a contribution to the far-field radar signature from the test target zone being imaged in the near field. This objective is achieved by examples of the radar measurement system and method described here.

### BRIEF DESCRIPTION OF THE DRAWINGS

FIG. 1 is a block diagram of an example of the radar measurement system.

FIG. 2 is a front view of an example of a radar measurement system.

FIG. 3 is a side view of an example of the base.

FIG. 4 is a top view of another example of the base

FIG. 5 is a side view of an example of the arm.

FIG. 6 is a top view of an example of the antenna system.

FIG. 7 is a front perspective view of an example of the radar test system

FIG. 8 is a diagram illustrating a radar measurement system taking radar measurements of a test target.

FIG. 9 is a block diagram illustrating certain functions of the radar measurement system.

### DETAILED DESCRIPTION OF EXAMPLE EMBODIMENTS

This disclosure describes exemplary embodiments, but not all possible embodiments of the devices, systems and methods. Where a particular feature is disclosed in the context of a particular example, that feature can also be used, to the extent possible, in combination with and/or in the context of other examples. The devices, systems, and methods may be embodied in many different forms and should not be construed as limited to only the features or examples described here.

There is a need for a radar measurement system that is compact and provides more flexibility in terms of where the antenna can be positioned relative to the test target. A radar measurement system that achieves these objectives is described here.

Certain examples of the radar measurement system provide a non-contact optical system for accurately positioning and orienting a radar antenna in multiple degrees of freedom, such as, for example, at least 6 degrees of freedom, with respect to an arbitrary three-dimensional test target. The positioning system features an optical image capture system attached to a radar antenna, which itself is attached to the arm of a multi-axis robot. A positioning algorithm uses an accurate reference image of the visible test target surface area to determine the radar antenna's pose from the measured optical image capture system data. In some examples, no fiducial marks are required to be placed on or around the test target. The test target reference image is typically sufficient to define the reference coordinate frame in which positioning of the radar antenna is performed.

Given a target with linear dimensions between 2-50 m without peculiar geometric symmetry/degeneracies, positioning accuracy and repeatability may typically be within 5 mm and 0.05 degrees in some examples. This enables repeatable, non-contact radar images to be taken of the test target, even if the test target and/or radar antenna is moved or reoriented between subsequent radar measurements.

The optical image capture-based radar antenna positioning system enables robust operation across a wide range of lighting conditions: indoor and outdoor, day and night. To achieve arbitrary 6-degree of freedom pose accuracies better than 5 mm and 0.05 degrees calls for careful intrinsic and extrinsic calibration of the optical image capture system, calibration of the robot, and the use of alignment algorithms.

In a particular example, the radar measurement system is a mobile, robot-controlled measurement system for performing repeatable near-field radar measurements of large aerospace systems, having dimensions on the order of 2-50 m, for example, using a linear radar array antenna. The near-field radar data are a function of both the system's geometrical and material make-up, as well as the position and orientation of the radar antenna—i.e., its 6 degree of freedom pose—with respect to the test target.

Antenna positioning poses unique challenges that have been solved by the alignment system and associated algorithms described here. One unique aspect of the alignment system is that it can use a large-scale industrial robot to place a large radar array in an arbitrary (i.e., non-trained) pose relative to large test targets to within tight 6-degree of freedom tolerances using a reference image of the test target's visible surfaces and optical image capture data. This creates a need for calibration of both the robot and optical image capture system and the development of unique algorithms for determining and subsequently setting the robot pose safely, precisely, accurately, and quickly.

The test target may be any apparatus on which radar signature measurements are being performed. Test targets may include, for example, aerospace structures, among many other possibilities.

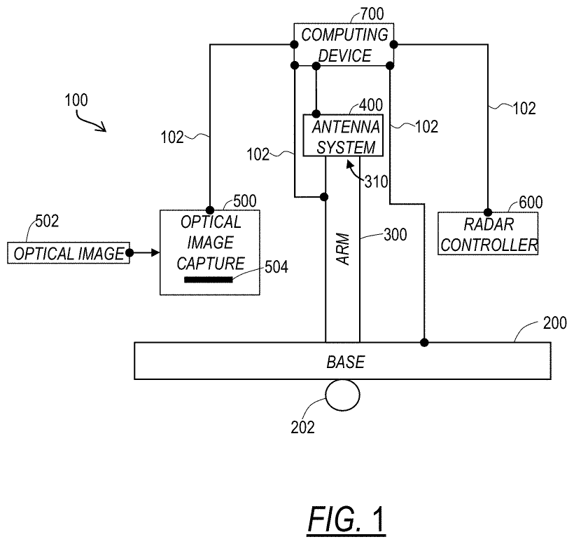

Referring to FIGS. 1, an example of the radar measurement system 100 includes a base 200, an arm 300, an antenna system 400, an optical image capture system 500, a radar controller 600, and a computing device 700.

The base 200 carries the arm 300, antenna system 400, optical image capture system 500, radar controller 600, and computing device 700. The base 200 includes a locomotion system 202 that allows the base 200 to move to different positions. The base 200 may be remotely controlled to drive the base 200 with the locomotion system 202 to different positions relative to a test target.

The arm 300 is carried by the base 200 and includes a distal end 310 distal from the base 200. The arm 300 is moveable in various directions for positioning the antenna system 400, which is mounted to the distal end 310. This functions allows the antenna system 400 to be moved by the arm 300 into different positions relative to the test target.

The antenna system 400 may include a transmit antenna and a receive antenna or may include a plurality of transmit and receive antennae arranged in an array. By using an antenna array, the aperture for measuring radar cross sections of test targets is much larger than conventional radar test systems are capable of measuring. Radio transmissions and reflections to and from the test target define a large cone over which data from the test target may be collected, thus providing test data over a larger cross section of the test target from a single position of the antenna system 400.

The optical image capture system 500 is configured to be able to record an optical image 502 of the test target. The optical image 502 is a three-dimensional rendering of the test target. The optical image capture system 500 may include one or more image capture devices 504. Examples of image capture devices include, but are not limited to, a visible light camera, a LIDAR camera, a stereovision camera, a laser range finder, electro optics image device, infrared imaging device, or the like for operation across a wide range of different ambient lighting conditions. The optical image capture system 500 may be aligned with the antenna system 400 so that the optical image capture system 500 records an optical image 502 of the same section of the test target the antenna system 400 is illuminating. This function allows the optical image 502 to be correlated with the radar data.

The radar controller 600 is in signal communication with the antenna system 400 for transmitting and receiving radar signals therefrom. The radar controller 600 may be used to generate different transmissions at various frequencies, typically in the 0.1 to 100 GHz range, for example. The radar controller 600 may also generate different waveforms for testing. An example of a radar controller 600 that may be used in a RadarMan radar system from QuarterBranch Technologies, Inc.

The computing device 700 is a computer or the like and may include typical features of a computer, including a processor P, non-transitory memory M, a keyboard, I/O ports, network connectivity device, and a graphical user interface. The computing device 700 stores program instructions on the memory that the processor executes for controlling the functions of the radar measurement system 100, such as moving the base 200 and arm 300, operating the optical image capture system 500 and radar controller 600, and processing and analyzing the radar data related to the test target. The computing device 700 is in operable communication with the other components via control circuitry 102 such as wiring or wireless connections.

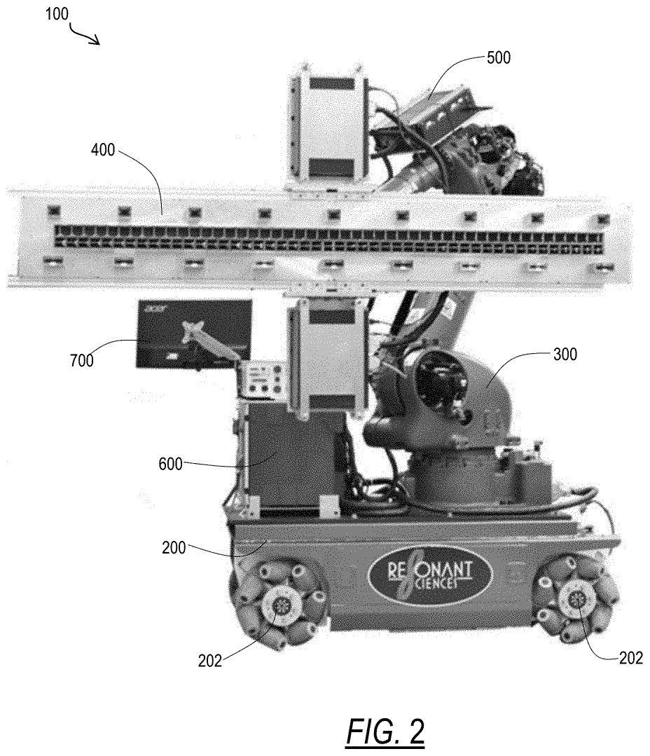

FIG. 2, is a more particular example of the radar measurement system of FIG. 1. The same reference numerals are used to refer to the corresponding features in FIG. 2.

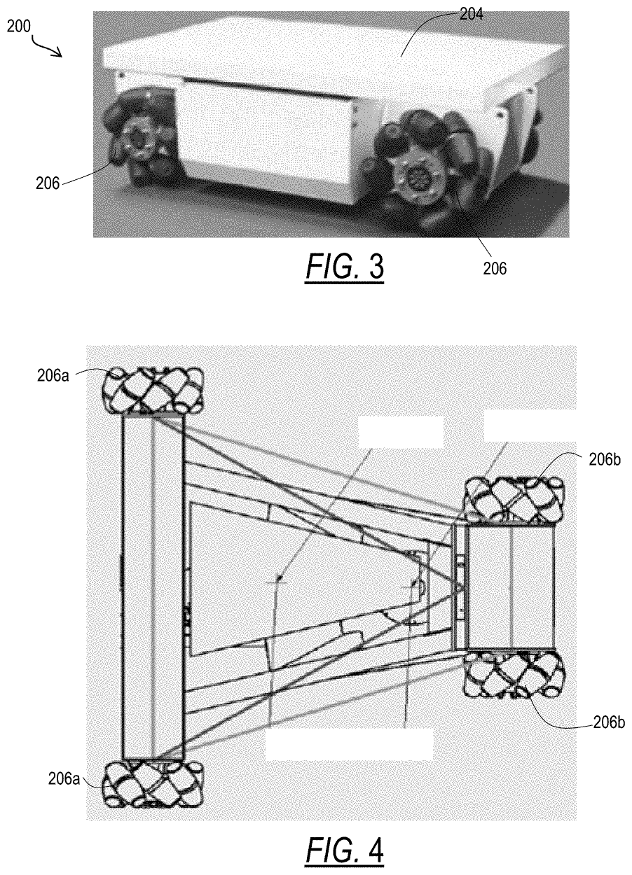

As shown in FIG. 3, The base 200 includes a platform 204 to which other components may be mounted. The locomotion system 202 in this example is a plurality of omnidirectional wheels 206 that permit the base 200 to move in any direction. The omnidirectional wheels 206 permit forward/reverse, left/right, diagonal, and rotation of the base 200 with needing to turn a set of wheels like an automobile. This function allows for accurate and rapid adjustment of the position of the base 200 relative to the test target. The base 200 also includes a motorized drivetrain that powers the omnidirectional wheels 206.

A different configuration of the base 200 is illustrated in FIG. 4. In this example, a first pair of omnidirectional wheels 206a is spaced farther apart than a second pair of omnidirectional wheels 206b so that the platform 204 assumes a substantially trapezoidal shape. The base 200 design of FIG. 4 is particularly useful when a smaller footprint and reduced weight are desired.

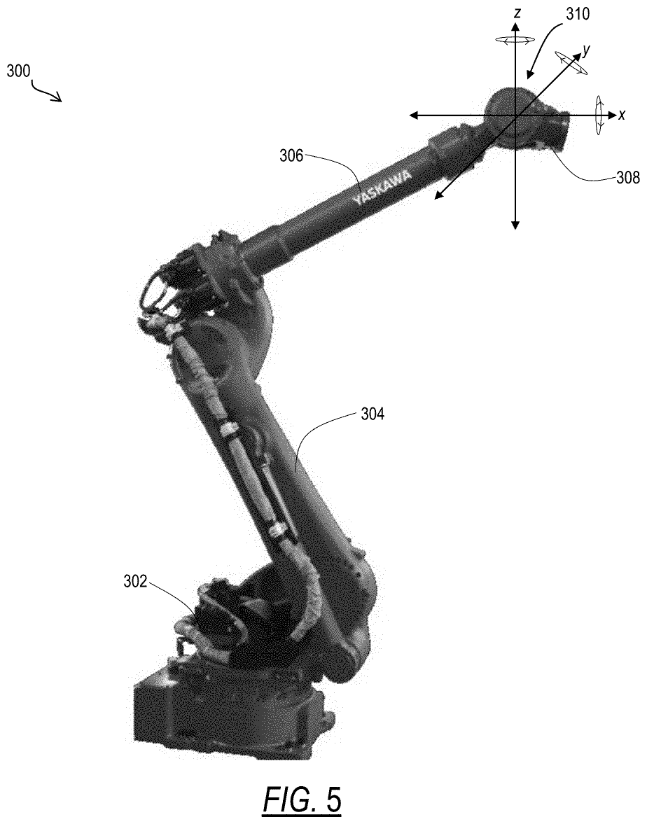

Referring to FIGS. 1, 2, and 5, the arm 300 may be a robotic arm having a bottom section 302 attached to the base 200, a lower arm 304 attached to the bottom section 302, an upper arm 306 attached to the lower arm 304, and an antenna system holder 308 attached at the distal end 310 of the upper arm 306.

The arm 300 permits motion of the antenna system 400 with six degrees of freedom, namely, movement in each of the x, y, z directions of a Cartesian coordinate system and rotation about each of the x, y, and z axes. An example of such an arm 300 that may be used in a Yaskawa Motoman Six Axis GP180-120, which is conventionally used in auto manufacturing.

The arm 300 permits accurate positioning and repositioning of the antenna system 400 in six dimensions relative to the test target. This function allows the radar measurement system 100 to generate three-dimensional radar cross section measurements if desired.

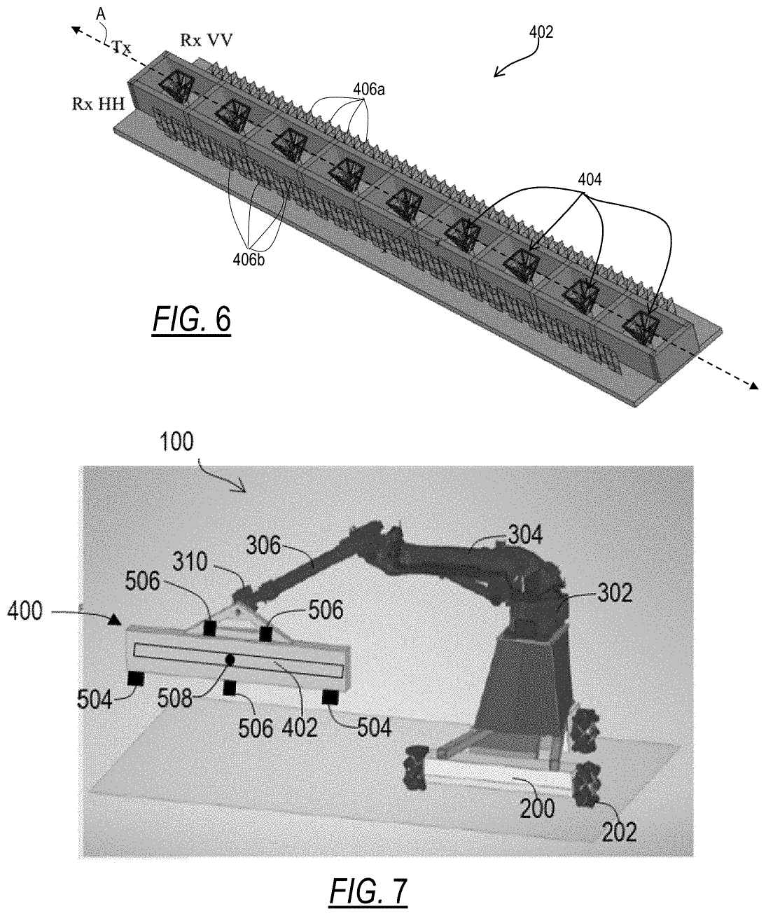

Referring to FIG. 6, an example of the antenna system 400 is an antenna array 402, including a plurality of transmit antennae 404 and receive antennae 406 arranged in a rectangular plane. The transmit antennae 404 are aligned along a lateral axis A of the antenna array 402. A first set of receive antenna 406a are arranged along a line parallel to the axis A. A second set of receive antennae 406b are arranged along a line parallel to the axis A on the opposite side of the transmit antennae 404. The first set of receive antennae 406a and second set of receive antennae 406b may have opposite polarization (HH or VV polarization).

The distance between the individual transmit antennae 404, individual receive antennae 406, and the distance between the transmit 404 and receive antenna 406 may vary depending on the desired performance. In the example shown, there are nine transmit antennae 404 spaced apart by about 12 inches and 48 receive antennae 406 on each side spaced apart by about 2 inches. This arrangement creates 96 phase centers with about 1 inch of separation. The length of the antenna array 402 example in FIG. 6 is about 8 feet, but the scope of possible antenna systems 400 is not limited to the example of FIG. 6. Likewise the dimensions and details of the antenna array 402 are given as examples and do not limit the scope of possible antenna arrays 402 that may be used.

Using a long antenna array 402 is advantageous because it increases the size of the measurement aperture. If the antenna array 402 is held in one position and used to make a radar cross section measurement, the data from the antenna array are recorded over the length of the array along the axis A. Thus, if the array has a length of 8 feet, as in the example of FIG. 6, measurements can be taken over an 8 foot distance. In a conventional radar cross section (“RCS”) test system, the antenna would have to be physically moved by eight feet in small increments to record the same data.

When the arm 300 is combined with the antenna system 400 of this example, the measurement aperture improves even more dramatically because the arm 300 can reposition the antenna system 400 over a large distance range in any direction without needing to move the base 200.

Referring to FIG. 7, an example of the optical image capture system 500 of the system 100 will be described in more detail. In this example, the optical image capture system 500 is used to determine the antenna system 400 position with respect to the test target. A pair of image capture devices 504 are mounted adjacent opposed ends of the antenna system 400. Three visible light cameras 506 are also mounted to the antenna system 400 in a triangular configuration about the center thereof. The image capture devices 504 and visible light cameras 506 provide real-time context imagery and also capture archival images of the test target once the antenna system 400 is successfully positioned.

The image capture devices 504, may be any image capture devices that capture an image of the test target T and permit the image to be converted into a measurement point cloud that includes coordinates for points along the test target's surface in the coordinate frame of the antenna system 400. In a particular example, the image capture devices 504 are LIDAR cameras. Such LIDAR cameras may be commercially-available Ouster OS0-128 scanners, for example. Such LIDAR cameras may include a bank of 128 laser sources and detectors that spin about an axis of symmetry, covering 360° in azimuth (φ) in 0.176° increments and covering 90° in elevation (θ) in 0.703° increments.

The image capture devices 504 may provide a time-of-flight based range measurement (r) produced by each source-detector pair of the image capture devices 504. Intrinsic calibration of the source-detector pairs elevation angles and knowledge of the azimuth angle enables the conversion of range-angle data (r,θ,φ) into Cartesian coordinates (x,y,z). Intrinsic calibration of the source-detector pairs mitigates range bias, ensuring accurate Cartesian coordinates. This set of Cartesian data points is denoted a “point cloud.”

In some cases, the arm 300 is used to perform small elevation changes about the center of the image capture devices 504 to collect additional image data, and put them into the original measurement's coordinate frame such that the elevation spacing is reduced and approximately equal to the azimuth spacing. For smaller test targets, the azimuth and elevation angular densities may be upsampled by collecting point clouds at various appropriate rotations about both the azimuth and elevation axes.

For each image capture devices 504 measurement (i=1 or 2), its corresponding cartesian coordinates Q_{O,i}—an N×4 array of N cartesian coordinates augmented by a fourth dimension of unit length, i.e. Q_{O,i}=[(x_{i,1}, y_{i,1}, z_{i,1}, 1), . . . , (x_{i,N}, y_{i,N}, z_{i,N}, 1)]—are transformed from the image capture device's 504 optical frame (0) to the robot base frame (B), which is defined as the center 508 of the antenna system 400. Specifically, the following composite homogeneous transformation is used: Q_{B,i}=T_{T}^{B}T_{O,i}^{T}Q_{O,i}. This construct enables the use of a 4×4 matrix to apply a transformation which includes both rotational and translational components.

Here, the homogeneous transformation T_{T}^{B} represents the transformation between the center 508 of the antenna system 400 and the robot base frame. The homogeneous transformation T_{O,i}^{T} represents the transformation between the i^{th} image capture device's 504 coordinate frame and the center 508 of the antenna system 400. This may be precisely determined during an extrinsic calibration procedure.

For image capture devices 504 measurements, the robot base frame is fixed; however, the arm 300 may move between subsequent measurements (e.g., elevation upsampling), and T_{T}^{B} accounts for this, ensuring the measurements are put into a common coordinate frame. The homogeneous transformations represent a rigid affine transformation encoding both the rotations and translations required to map from one coordinate frame to the other. The general form of a rigid homogeneous transformation is the 4×4 matrix given by:

$$T = ( \begin{matrix}R ( \vec{ω} ) & \vec{t} \\ \vec{0} & 1\end{matrix} )$$

where R(\vec{ω}) is a 3×3 rotation matrix defined by the three Euler angles \vec{ω}=(ωₓ, ω_{y}, ω_{z}); \vec{t}=(tₓ, t_{y}, t_{z}) is a 3×1 cartesian translation vector; and \vec{0} is a 1×3 vector of zeros. Thus, each homogeneous transformation matrix has the form:

$$T = ( \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{z} \\ 0 & 0 & 0 & 1\end{matrix} )$$

where rᵢⱼ are the explicit components of the rotation matrix defined by the specific rotation angles ωₓ, ω_{y}, and ω_{z}.

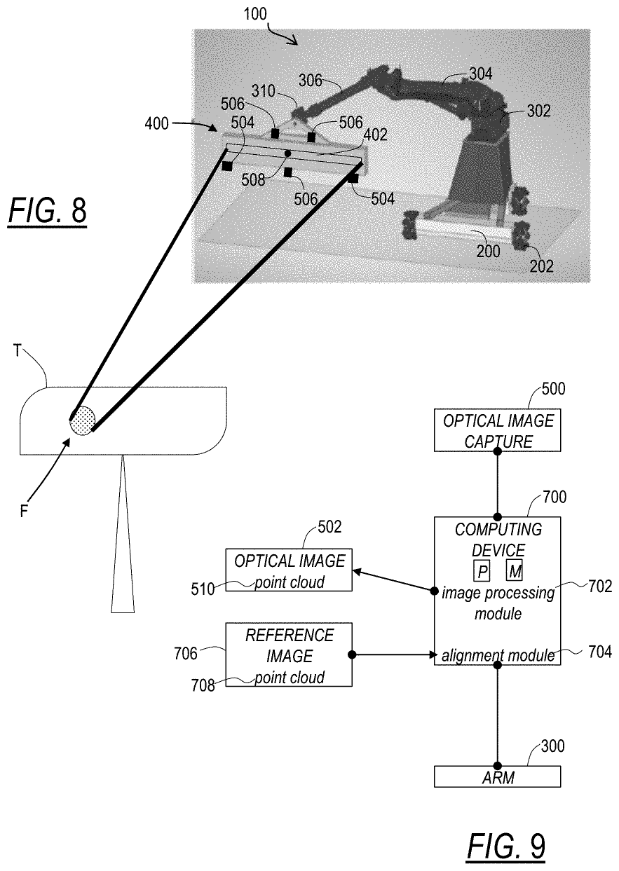

Referring to FIG. 8, the optical image capture system 500 is oriented to capture an optical image of the test target T where the antenna system 400 is oriented to measure the test target T.

In FIG. 8, the radar measurement system 100 is positioned a distance away from the test target T. The antenna system 400 is used to take a test measurement at a focal zone F on the test target T. The optical image capture system 500 captures image data and visible images of the focal zone F using visible light cameras 506 and image capture devices 504. The image capture devices 504 scan the focal zone F to produce a three dimensional image thereof.

Referring to FIG. 9, the optical image capture system 500 communicates the data it captures to the computing device 700. The computing device 700 executes an image processing module 702 including program instructions for processing the data. The image processing module 702 converts the optical image capture system 500 data into an optical image 502 readable by the computing device 700. The optical image 502 may be a two-dimensional or three-dimensional image with features of the test target T having corresponding coordinates in two-dimensional or three-dimensional space, such as a point cloud 510, for example. The computing device 700 stores the optical image 502 produced by the image processing module 702 on the computing device's 700 memory M.

An alignment module 704 of the computing device 700 includes program instructions that compare a reference image 706 to the optical image 502 to determine how the antenna system 400 is aligned relative to the test target T. The reference image 706 is a data file including a pre-defined image of the test target T. The reference image 706 may be a computer aided design (CAD) file or any other image file of the test target in which the test target's T surface can be or is already mapped with coordinates, such as a test target point cloud 708 representing points along the test target's surface.

The alignment module 704 calculates the alignment of the optical image capture system 500 relative to the test target T by comparing the optical image 502 to the reference image 706. An algorithm identifies points on the test target T in the focal zone F and maps corresponding points from the reference image 706 as will be explained below. This can be performed in six degrees of freedom. This function allows for accurate placement of the antenna system 400 with respect to the focal zone F to reduce or substantially eliminate error due to uneven ground, test target T misplacement, small changes to the test target T, and tilting of the test target T, among other possibilities.

If the optical image capture system 500 is misaligned, the computing device 700 instructs the arm 300 to reposition the antenna system 400 to reduce and/or substantially eliminate the alignment error.

The computing device 700 may include program instructions to determine a radar cross section of the test target using the data generated by the antenna system 400. Conventional radar cross section algorithms may be used for this function.

For the alignment module 704, the reference image 706 for the test target's T visible surfaces may be uniformly sampled to produce a dense set of Cartesian coordinates Pᵢ representing a theoretical test target point cloud in the test target's T coordinate system (W). By determining the homogeneous transformation T_{B}^{W} that maps the measured point cloud Q_{B} into the target's T coordinate system, the robot base frame is now known in the reference image's 706 coordinate frame, thereby establishing the antenna system's 400 current 6-degree of freedom position in relation to the test target T. The 6-degree of freedom transformation T_{B}^{W}(\vec{ω},\vec{t}) is the one that aligns the optical image point cloud 510 and test target point cloud 708.

Algorithmically, this is achieved by setting up a cost function C(\vec{ω},\vec{t}) defined by the distances between corresponding points between each point cloud 510, 708 and minimizing it. First, non-target points are filtered from the optical image point cloud 510. Next, correspondences between the optical image point cloud 510 and test target point cloud 708 are assigned. Then the following cost function is evaluated C(\vec{ω},\vec{t})=Σᵢ₌₁^{M}ρ(∥\vec{p}ᵢ−T_{B}^{W}(\vec{ω},\vec{t})\vec{q}ᵢ∥²,γ)

where \vec{p}ᵢ are points from the reference image 706 derived test target point cloud 708 P and \vec{q}ᵢ are the corresponding points from the optical image point cloud 510 in robot base coordinates Q_{B}. An optimization algorithm is used to minimize C(\vec{ω},\vec{t}) over the 6 free parameters in \vec{ω} and \vec{t}, resulting in an optimal estimate of the location of the robot base frame in the reference image 706 coordinate frame. Robustness to outliers (i.e., points in the optical image point cloud 510 that do not correspond to points in the test target point cloud 708 may be introduced by the robust weighting kernel ρ parameterized by γ, which affects how strongly outliers are downweighted. Algorithms may automatically identify corresponding points between measured and test target point clouds and remove most non-corresponding points. The optimal downweighting parameter may be selected manually or automatically. These developments are useful to ensure the optimizing algorithm converges to the correct solution.

Once the current position, T_{B}^{W}(c), of the robot is known in the reference frame, the current position of the antenna system 400, T_{T}^{W}(c)=T_{B}^{W}(c)T_{T}^{B}(c), is also known. The transformation of the robot position, in base coordinates, required to move the current antenna system 400 position, T_{T}^{W}(c), to the desired radar pose, T_{T}^{W}(d), is given by: T_{T}^{B}(d)=(T_{B}^{W}(c))⁻¹T_{T}^{W}(d).

A robot kinematics algorithm may then be used to compute the optimal joint angles and a collision-free path such that the new 6-degree of freedom position T_{T}^{B}(d) is achieved. A second iteration of determining—and setting, if necessary—the 6-degree of freedom pose is then performed. It may be advantageous to verify the pose since for large robot moves affecting the center of gravity, the relationship between the robot's coordinate system and the base 200 it is attached to can change slightly. When this occurs, the subsequent position adjustment is typically on the order of 1 cm and 0.1 degrees.

An example of how the radar measurement system 100 may aligned with the test target T is now described.

The test target T is initially positioned within the field of view of the optical image capture devices 504 such that the optical image capture devices 504 are able to image the test target T. Using the optical image capture devices 504, the image processing module 702 then generates a point cloud of the surrounding area and transforms the point cloud to the robot base frame coordinate system, which in the example shown is the center 508 of the antenna system 400, which is the optical image point cloud 510. The image processing module 702 uses the test target point cloud 708 from the reference image 706 to self-locate the antenna system's 400 current position relative to the test target T.

Knowing the current antenna system's 400 position, the alignment module 704 moves the antenna system 400 to the desired position using the derived current position. If the robot arm 300 cannot reach the desired position, the base 200 will move the radar measurement system 100 closer to the desired position. The process is iterated until the final position is correct within a desired tolerance.

The devices, systems, and methods may be used to provide a relatively accurate estimate of the contribution to the far-field radar signature from the zone being imaged in the near field.

This disclosure describes certain example embodiments, but not all possible embodiments of the devices, systems, and methods. Where a particular feature is disclosed in the context of a particular example, that feature can also be used, to the extent possible, in combination with and/or in the context of other embodiments. The devices and associated methods may be embodied in many different forms and should not be construed as limited to only the embodiments described here.

That which is claimed is:

1. A radar measurement method comprising aligning a radar antenna with a test target by (a) comparing a pre-defined reference image of the test target with an image capture device image of the test target and (b) moving a radar antenna that illuminates the test target to a radar antenna position relative to the test target based on (a).

2. The method of claim 1, wherein the pre-defined reference image of the test target includes a data file of a test target point cloud with coordinates defined in a test target coordinate frame defining a test target position.

3. The method of claim 1, wherein the image capture device image includes a measurement point cloud with coordinates of the radar antenna defined in a radar antenna coordinate frame defining the radar antenna position.

4. The method of claim 1, wherein:
the pre-defined reference image of the test target includes a data file of a test target point cloud with coordinates defined in a test target coordinate frame defining a test target position;
the image capture device image includes a measurement point cloud with coordinates of the radar antenna defined in a radar antenna coordinate frame defining the radar antenna position; and
the radar antenna position is moved by a robotic arm in at least six degrees of freedom.

5. The method of claim 1, wherein comparing the pre-defined reference image of the test target with the image capture device image of the test target includes comparing a test target point cloud with coordinates defined in a test target coordinate frame defining a test target position to a measurement point cloud with coordinates of the radar antenna defined in a radar antenna coordinate frame defining the radar antenna position.

6. The method of claim 1, wherein
the pre-defined reference image of the test target includes a data file of a test target point cloud with coordinates defined in a test target coordinate frame defining a test target position;
the image capture device image includes a measurement point cloud with coordinates of the radar antenna defined in a radar antenna coordinate frame defining the radar antenna position; and
comparing the pre-defined reference image of the test target with an image capture device image of the test target includes transforming the test target coordinate frame and measurement coordinate frame onto a common coordinate frame.

7. The method of claim 1, further comprising a computing device including an image processing module with program instructions that perform (a) and an alignment module with program instructions that perform (b).

8. A radar measurement system comprising
a radar antenna that illuminates a test target and is alignable relative to the test target;
a computing device storing a pre-defined reference image of the test target and an image capture device image of the test target; and
a robot that moves the radar antenna to a radar antenna position relative to the test target based on a comparison by the computing device of the reference image and image capture device image.

9. The system of claim 8, wherein the pre-defined reference image of the test target includes a data file of a test target point cloud with coordinates defined in a test target coordinate frame defining a test target position.

10. The system of claim 8, wherein the image capture device image includes a measurement point cloud with coordinates of the radar antenna defined in a radar antenna coordinate frame defining the radar antenna position.

11. The system of claim 8, wherein:
the pre-defined reference image of the test target includes a data file of a test target point cloud with coordinates defined in a test target coordinate frame defining a test target position;
the image capture device image includes a measurement point cloud with coordinates of the radar antenna defined in a radar antenna coordinate frame defining the radar antenna position; and
the robot moves the antenna position in at least six degrees of freedom.

12. The system of claim 8, wherein the computing device includes program instructions that compare the pre-defined reference image of the test target with the image capture device image of the test target by comparing a test target point cloud with coordinates defined in a test target coordinate frame defining a test target position to a measurement point cloud with coordinates of the radar antenna defined in a radar antenna coordinate frame defining the radar antenna position.

13. The system of claim 8, wherein
the pre-defined reference image of the test target includes a data file of a test target point cloud with coordinates defined in a test target coordinate frame defining a test target position;
the image capture device image includes a measurement point cloud with coordinates of the radar antenna defined in a radar antenna coordinate frame defining the radar antenna position; and
the computing device includes program instructions that compare the pre-defined reference image of the test target with the image capture device image of the test target by comparing a test target point cloud with coordinates defined in a test target coordinate frame defining a test target position to a measurement point cloud with coordinates of the radar antenna defined in a radar antenna coordinate frame defining the radar antenna position.

14. The system of claim 8, wherein the computing device includes program instructions to execute an image processing module with program instructions that compares the reference image and image capture device image and an alignment module that moves the radar antenna.

15. A radar measurement system comprising
a radar antenna that illuminates a test target and is alignable relative to the test target;
a computing device storing a pre-defined reference image of the test target and an image capture device image of the test target; and
a robot that moves the radar antenna to a radar antenna position relative to the test target based on a comparison by the computing device of the reference image and image capture device image;
wherein the computing device includes program instructions that compare the pre-defined reference image of the test target with the image capture device image of the test target by comparing a test target point cloud with coordinates defined in a test target coordinate frame defining a test target position to a measurement point cloud with coordinates of the radar antenna defined in a radar antenna coordinate frame defining the radar antenna position.

16. The system of claim 15, wherein the pre-defined reference image of the test target includes a data file of a test target point cloud with coordinates defined in a test target coordinate frame defining a test target position.

17. The system of claim 15, wherein the image capture device image includes a measurement point cloud with coordinates of the radar antenna defined in a radar antenna coordinate frame defining the radar antenna position.

18. The system of claim 15, wherein:
the pre-defined reference image of the test target includes a data file of a test target point cloud with coordinates defined in a test target coordinate frame defining a test target position;
the image capture device image includes a measurement point cloud with coordinates of the radar antenna defined in a radar antenna coordinate frame defining the radar antenna position; and
the robot moves the antenna position in at least six degrees of freedom.

19. The system of claim 15, wherein the computing device includes program instructions that compare the pre-defined reference image of the test target with the image capture device image of the test target by comparing a test target point cloud with coordinates defined in a test target coordinate frame defining a test target position to a measurement point cloud with coordinates of the radar antenna defined in a radar antenna coordinate frame defining the radar antenna position.

20. The system of claim 15, wherein the computing device includes program instructions to execute an image processing module with program instructions that compares the reference image and image capture device image and an alignment module that moves the radar antenna.
